(19) United States
(12) Patent Application Publication
(10) Pub. No.: US 2015/0205918 A1
(43) Pub. Date: Jul. 23, 2015

(54) SERVICE PROVIDER IDENTIFICATION IN A COMPUTER NETWORK ENVIRONMENT

(71) Applicant: Par8o, Inc., Cambridge, MA (US)

(72) Inventors: Daniel Palestrant, Newton, MA (US); Adam Sharp, Carmel, IN (US); Ian Goodrich, Portland, OR (US); Michael Roc Hargrove, Cambridge, MA (US)

(73) Assignee: Par8o, Inc., Cambridge, MA (US)

(21) Appl. No.: 14/161,394

(22) Filed: Jan. 22, 2014

(51) Int. Cl. G06F 19/00; G06Q 50/24

(52) U.S. Cl. CPC G06F 19/322; G06Q 50/24

(57) ABSTRACT

A data processing system can receive, from a referring computing device, an indication to obtain electronic medical record data displayed by the referring computing device. The data processing system can obtain, via the computer network, the electronic medical record data, and can generate a referral request document based on the electronic medical record data. The data processing system can provide the referral request document from the referral network engine to the referring computing device via the computer network for display by the referring computing device, and can prompt for referral completion data using the referral request document. The data processing system can receive, via the computer network, an indication of a complete referral based on the referral completion data, and can obtain, by the data processing system, the complete referral.

### BACKGROUND

Service providers provide a good or service to a customer. A service provider may be unable or unwilling to offer a particular good or service to a customer. In such a case, the customer may utilize a different service provider to accommodate the customer's needs.

### SUMMARY

At least one aspect is directed to a computer implemented method of providing information via a computer network. The method can receive, from a referring computing device, an indication for a data processing system to obtain electronic medical record data via the referring computing device. The method can obtain, by a data processing system and via the computer network, the electronic medical record data, and can generate, by a referral network engine of the data processing system, a referral request document based on the electronic medical record data. The method can provide the referral request document from the referral network engine to the referring computing device via the computer network for display by the referring computing device, and can prompt, via the referral request document, for referral completion data. The method can receive, by the data processing system via the computer network, an indication of a complete referral based on the referral completion data, and can obtain, by the data processing system, the complete referral.

At least one aspect is directed to a system of providing information via a computer network. The system includes a data processing system having a referral network engine and a database. The data processing system can receive, from a referring computing device, an indication to obtain electronic medical record data displayed by the referring computing device, and can obtain, via the computer network, the electronic medical record data. The referral network engine of the data processing system can generate a referral request document based on the electronic medical record data, and can provide the referral request document from the referral network engine to the referring computing device via the computer network for display by the referring computing device. An indication of a complete referral based on the referral completion data can be received, via computer network transmission, and the complete referral can be obtained.

At least one aspect is directed to a non-transient computer readable medium having instructions to provide information via a computer network. The instructions comprise instructions to receive, from a referring computing device, an indication to obtain electronic medical record data displayed by the referring computing device, and to obtain, via the computer network, the electronic medical record data. The instructions comprise instructions to generate a referral request document based on the electronic medical record data, and to provide the referral request document to the referring computing device via the computer network for display by the referring computing device. The instructions comprise instructions to prompt for referral completion data via the referral request document, to receive, via the computer network, an indication of a complete referral based on the referral completion data, and to obtain the complete referral.

These and other aspects and implementations are discussed in detail below. The foregoing information and the following detailed description include illustrative examples of various aspects and implementations, and provide an overview or framework for understanding the nature and character of the claimed aspects and implementations. The drawings provide illustration and a further understanding of the various aspects and implementations, and are incorporated in and constitute a part of this specification.

### BRIEF DESCRIPTION OF THE DRAWINGS

The accompanying drawings are not intended to be drawn to scale. Like reference numbers and designations in the various drawings indicate like elements. For purposes of clarity, not every component may be labeled in every drawing. In the drawings:

FIG. 1 is a block diagram depicting one example of a system for providing information via a communications network, according to an illustrative implementation;

FIG. 2 is an example implementation illustrating a display of a data request document overlaying a subject data display;

FIG. 2A is an example implementation illustrating a display of a data request document overlaying a subject data display;

FIG. 3 is an example implementation illustrating a display of a data request document overlaying a subject data display;

FIG. 4 is an example implementation illustrating a display of a data request document overlaying a subject data display;

FIG. 5 is an example implementation illustrating a display of a data request document overlaying a subject data display;

FIG. 6 is an example implementation illustrating a display of a data request document overlaying a subject data display;

FIG. 7 is an example implementation illustrating a display of a data request document overlaying a subject data display;

FIG. 8 is an example implementation illustrating a display of a data request document overlaying a subject data display;

FIG. 9 is an example implementation illustrating a display of a data request document overlaying a subject data display;

FIG. 10 is an example implementation illustrating a display of a data request document overlaying a subject data display;

FIG. 11 is a flow chart depicting an example implementation of providing information via a computer network;

FIG. 12 is a flow chart depicting an example implementation of providing information via a computer network; and

FIG. 13 is a block diagram illustrating a general architecture for a computer system that may be employed to implement elements of the systems and methods described and illustrated herein, according to an illustrative implementation.

### DETAILED DESCRIPTION

Following below are more detailed descriptions of various concepts related to, and implementations of, methods, apparatuses, and systems of providing information via a computer network. The various concepts introduced above and discussed in greater detail below may be implemented in any of numerous ways, as the described concepts are not limited to any particular manner of implementation.

In a computer networked environment, a data processing system can include a referral network engine to facilitate creation of a referral on behalf of a service provider as the service provider (or a delegate of the service provider) interacts with an application executing on a referring computing device. The referral network engine can identify a request for a referral based on activity of the referring computing device. The referral network engine can communicate with the referring computing device to obtain data that can be used by the referral network engine to generate a referral. The referral can be provided to a recipient computing device where another service provider can accept or decline the referral.

For example, in a health care environment, a patient may be visiting a primary physician as part of a physical examination. From this examination, the primary physician can determine that the patient should see a second physician (e.g., a physician with a particular specialization) for further examination. The primary physician (or a delegate) can interface with a program or application executing on the referring computing device to enter information from the examination into an electronic medical record for the patient.

During updating of the patient's electronic medical record or other interaction with the referring computing device, for example, the primary physician can indicate a need to refer the patient to another physician. The referral network engine can obtain an indication of this need for a referral, and via computer network communication can provide data related to the referral for display in a user interface by the referring computing device to the primary physician. For example, this data can include prompts for additional data from the primary physician that the referral network engine uses to complete the referral.

The data provided by the referral network engine can be provided via a computer network for display by the referring computing device without altering, interacting with, or changing the electronic medical record application executed by the referring computing device. For example, a referral document, (e.g., a web page template) that can prompt for data to complete the referral can be provided by the referral network engine to the referring computing device via a computer network communication in the form of a user interface, pop up window, overlay, or web page display. These interactions can occur while an electronic medical record application is open or executing on the referring computing device. Thus, in some implementations, a primary physician can have a referral generated seamlessly during time spent by the primary physician updating or otherwise interacting with a patient's electronic medical record.

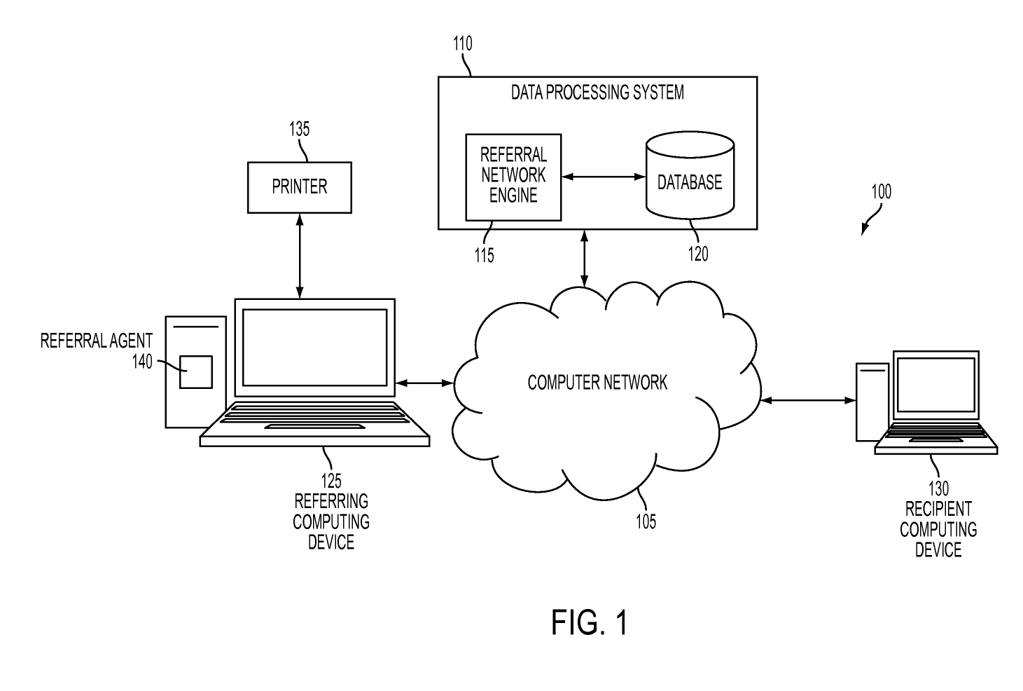

FIG. 1 illustrates an example system 100 for providing information via a communications network, such as at least one computer network 105. The network 105 can include computer networks such as the internet, local, wide, metro or other area networks, intranets, satellite networks, other computer networks such as voice or data mobile or landline phone communication networks, and combinations thereof.

The system 100 can also include at least one data processing system 110. The data processing system 110 can include at least one physical or virtual server. For example, the data processing system 110 can include a plurality of servers located in at least one data center or server farm. In one implementation, the data processing system 110 includes at least one referral network engine 115. The data processing system 110 can also include at least one database 120. The referral network engine 115 can include at least one processing unit or other logic device such as programmable logic arrays configured to communicate with the database 120 and with other computing devices via the network 105. The referral network engine 115 can be a separate component, a single component, or part of the data processing system 110. In one implementation, the referral network engine 115 is part of at least one server. The data processing system 110 can include at least one logic device such as a processor to communicate via the network 105, for example with the referral network engine 115 or the database 120.

The data processing system 110 and its components (e.g., the referral network engine 115) can communicate via the network 105 with computing devices such as at least one referring computing device 125 and at least one recipient computing device 130. The referring computing device 125 and the recipient computing device 130 can include desktop computers, laptop computers, physical or virtual servers, tablet computers, smart phones, personal digital assistants, mobile or landline phones, or facsimile machines for example. In some implementations, the data processing system 110 communicates with the referring computing device 125 to create a referral, and the data processing system 110 or the referring computing device 125 can provide the referral to the recipient computing device 130 via the network 105.

The referring computing device 125 can be associated with a referring service provider, such as a health care provider. For example, the referring computing device 125 can be located in a hospital, doctor's office, health clinic, subject or patient's home or office, a health care provider facility, or a health maintenance organization facility. The referring computing device 125 can communicate with at least one peripheral device such as at least one printer 135. The printer 135 can receive print commands from a printer driver of the referring computing device 125 to print documents or images based on the print commands.

The system 100 can include at least one referral agent 140. For example, the referral agent 140 can include a script, executable, module, or program installed on the referring computing device 125. The referral agent 140 can execute on the referring computing device 125 to communicate with the data processing system 110 and with the referring computing device 125 to, for example, provide referral data and other associated data between the data processing system 110 and the referring computing device 125. The referral agent 140 can also be installed on a computing device (e.g., server) of the data processing system 110. In some implementations, the data processing system 110 includes the referral agent 140 when the referral agent 140 is installed on the referring computing device 125. In this example, the referral agent 140 is part of the data processing system 110 (e.g., part of the referral network engine 115). In some implementations, the referral agent 140 includes a hardware component, appliance, or device.

A user of the referring computing device 125 (e.g., a health care provider) can have a desire to refer a subject (e.g. a patient) to another person or entity. For example, a user (e.g., health care provider or delegate) can interface with the referring computing device 125 to execute a target application such as an electronic medical record application. This application can execute to display the subject's electronic medical record at the referring computing device 125. During review or updating of the electronic medical record, the user can decide that the subject would benefit from a referral to a second health care provider, such as a specialist in a particular condition.

In some implementations, the data processing system 110 can receive, from the referring computing device 125, an indication for the data processing system 110 to obtain electronic medical record data. This indication can reflect a request by the user to generate a referral. For example, the referral agent 140 or the referral network engine 115 can detect the indication to obtain electronic medical record data. The electronic medical record data can include data displayed by the referring computing device 125 during execution of an electronic medical record application by the referring computing device 125, or data included in the electronic medical record of a subject that is not displayed by the referring computing device 125.

For example, a subject (e.g., patient) can undergo an annual physical examination at the office of a service provider (e.g., physician). Before, during, or subsequent to the examination, the service provider can access an electronic medical record application using the referring computing device 125 to view or edit electronic medical record data concerning the patient. For example, the service provider can update the patient's electronic medical record data to indicate that the subject has a heart condition. In so doing, the service provider can determine that the subject should see a specialist, e.g., a physician specializing in heart conditions. The referring computing device 125, responsive to input from the service provider, can generate a communication (e.g., a request for a referral). The data processing system 110 (e.g., the referral agent 140 installed at the referring computing device 125) can obtain this communication via a network 105 communication.

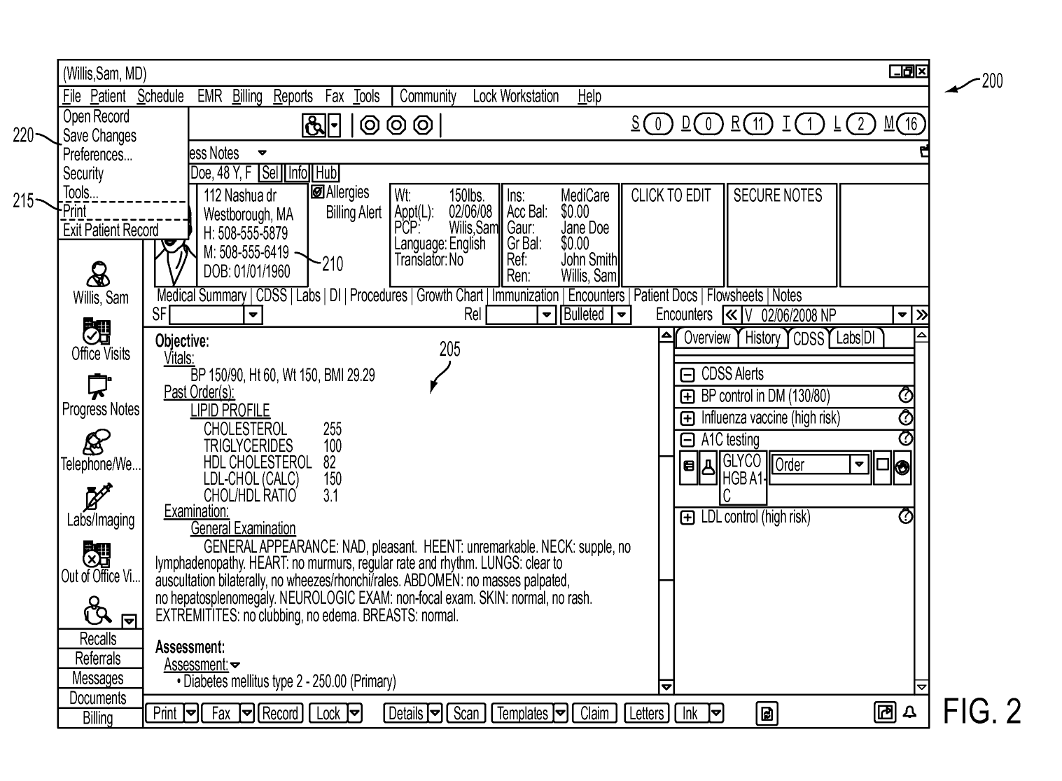

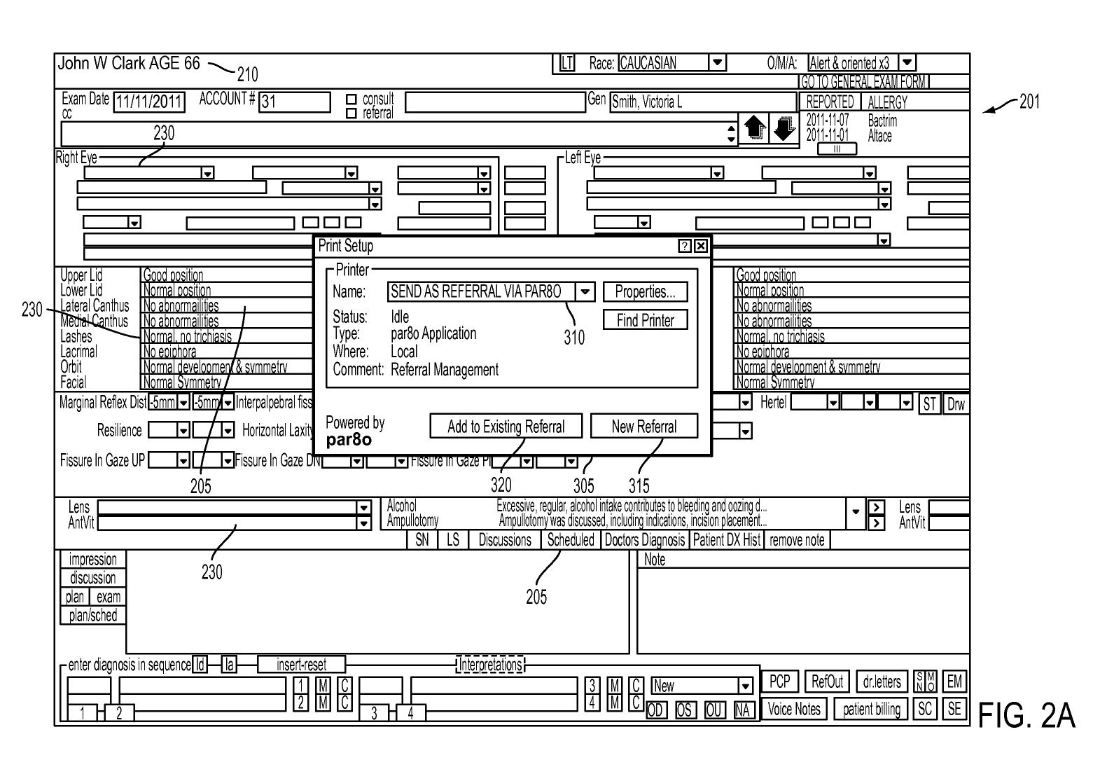

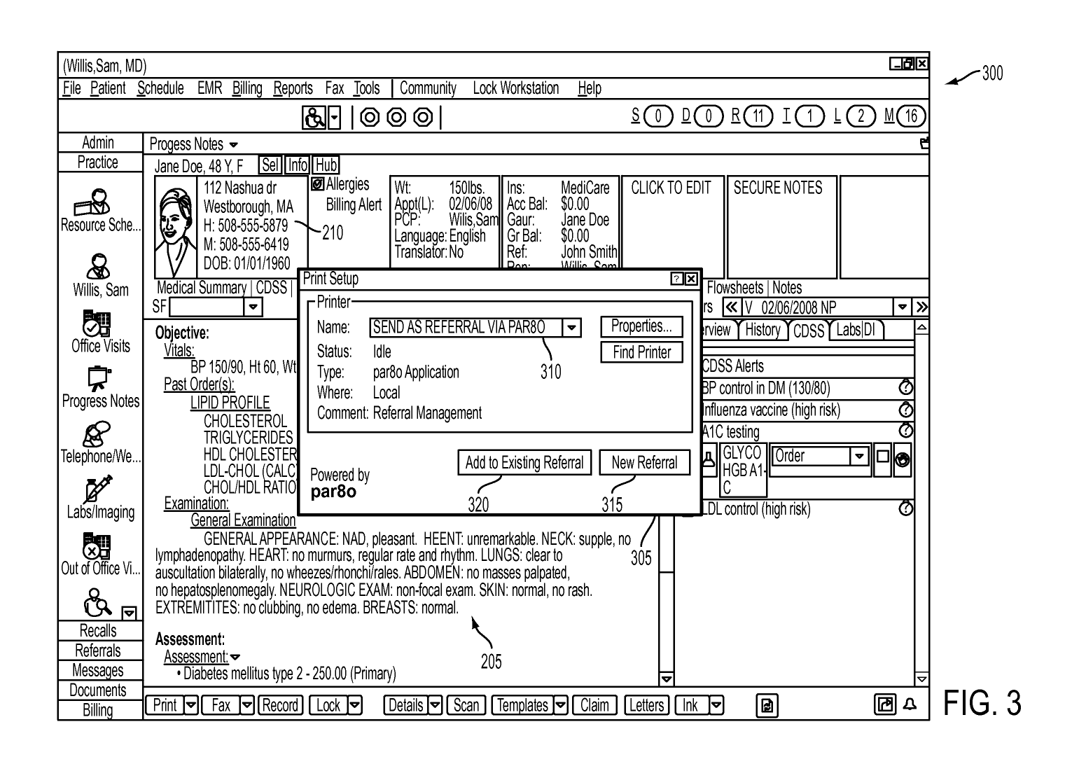

For example, FIG. 2, FIG. 2A, and FIG. 3 depict screenshots 200, 201, and 300, respectively, of electronic medical record data 205 of a subject 210, identified as 48 year old female Jane Doe in FIG. 2 and FIG. 3, and as 66 year old John Clark in FIG. 2A. The screenshots 200, 201, or 300 can be displayed by the referring computing device 125. The electronic medical record data 205 can be generated by an electronic medical record application executing on the referring computing device 125 independently of the data processing system 110. In some implementations, the data processing system 110 including the referral agent 140 do not control execution of the electronic medical record application, which instead is independently installed on and executed by the referring computing device 125.

The electronic medical record data 205 can include data about the subject 210 such as examination information, medical history, medical assessment information, diagnoses, contact information, or insurance information, for example. In some implementations, a service provider viewing or editing the electronic medical record data 205 can determine or verify that the subject 210 is in need of a referral to a second service provider.

The service provider can initiate the process of creating a referral by entering or inputting a referral command into an interface of the referring computing device 125. The referral command can be in the form of at least one keystroke (e.g., CTRL+ALT+R) received from a keyboard of the referring computing device 125, a mouse, touchpad, or trackball click, a print command, or a screenshot capture command. The data processing system 110 (or component thereof such as the referral agent 140) can receive these commands and identify them as indication for the data processing system 110 to obtain medical record (or other) data from the referring computing device 125. For example, during display of the electronic medical record data 205, the service provider can enter a print command, e.g. a CTRL+P keystroke, or by selecting the print icon 215 from the drop down menu 220 as in the example of FIG. 2. Responsive to this selection, the service provider may have the option to select from a list of printers to print the electronic medical record data 205. For example, the service provider can select the printer 135. In this example, responsive to selecting the printer 135 the referring computing device 125 can communicate with the printer 135 to print the electronic medical record data at the printer 135.

In some implementations, rather than selecting the printer 135, responsive to selecting the print icon 215 the service provider can select an option to send a referral to the data processing system 110. The data processing system 110 (or component thereof such as the referral agent 140 executing at the referring computing device 125) can detect this selection. Responsive to selecting the print icon 215, the data processing system 110 can provide a setup dialog box 305 for display by the referring computing device 125. The setup dialog box 305 can be a web page, pop-up window, overlay, or online document configured for display by the referring computing device 125 concurrently with the electronic medical record data 205.

Instead of providing the option to print electronic medical record data 205 or other data to the printer 135, the setup dialog box 305 can provide the option to create a referral via communication with the data processing system 110. For example, an interface 310 (e.g., a drop down window) of the setup dialog box can display a list of options. The list of options, not depicted in FIG. 3, can include the printer 135, an option to create or send a referral to the data processing system 110, or other printers configured for communication with the referral computing device 125. In the example of FIG. 3, the interface 310 displays a selected option to send a referral to the data processing system 110, (e.g., “send as referral via Par8o” in the example of FIG. 3).

In some implementations, the setup dialog box 305 is not part of and not controlled by the electronic medical record application executing on the referring computing device 125. Rather, in this example the data processing system 110 provides the setup dialog box 305 for display by the referring computing device 125. For example, the referral agent 140 can intercept, receive, or detect selection by the user of the referral computing device 125 of the option to create or send a referral to the data processing system 110. The data processing system 110 can obtain or receive this indication from the referral agent 140 via a communication through the computer network 105 and the referral agent 140 or other data processing system 110 component (e.g., the referral network engine 115) can provide the setup dialog box 305 for display by the referral computing device 125. In some implementations, the setup dialog box 305 is a web page, pop-up window, or other online document hosted by the data processing system 110 and provided by the data processing system 110 to the referring computing device 125 for display by the referring computing device 125.

The user of the referring computing device 125 can select an option to create a referral via the interface 310 and send this request for a referral to the data processing system 110, where it can be received, for example as an indication for the data processing system 110 to obtain the electronic medical record data 205 and use this data to create a referral. For example, the user can actuate (e.g., click) at least one button, link, or other interface of the setup dialog box 305 such as the new referral button 315 (e.g., to create a new referral for a subject) or the add to existing referral button 320 (e.g., to update or change existing referral data for a subject stored in the database 120). The referral agent 140 detects this actuation and provides the electronic medical record data 205 to the data processing system 110 via the computer network 105. The electronic medical record data 205 can also be obtained by the data processing system 110 via the network 105 without the use of the referral agent 140.

The electronic medical record data 205 can include data displayed by the referring computing device 125. For example, the electronic medical record data 205 that would have been sent to the printer 135 had the user selected the printer 135 from a list of options provided by the interface 310 is instead sent to and received by the data processing system 110. The electronic medical record data 205 can include data displayed above the fold by a monitor of the referring computing device 125 well as data displayed responsive to user action such as a scrolling action. For example, the electronic medical record data 205 can include two pages of data with the first page displayed by the referring computing device 125 and the second page displayed responsive to a user scrolling action or other command such as a page-down keystroke entry. In this and other examples, the data processing system 110 obtains electronic medical record data 205 without altering execution of the electronic medical record application.

The referring computing device 125 can convert the electronic medical record data 205 to postscript (e.g., an unstructured representation of the electronic medical record data 205). A printer driver or other component of the referring computing device 125 can generate or provide this unstructured medical record data as postscript data to the referral agent 140 (e.g., a port monitor) for further communication via the computer network 105 to the referral network engine 115. The data processing system 110 need not control or change the operation of the electronic medical record application to obtain the electronic medical record data 205. For example, responsive to the selection of the print icon 215 (e.g., a print command), the electronic medical record data 205 displayed during execution of the electronic medical record application can be sent to the data processing system 110 rather than to the printer 135 without reprogramming, updating, or interfering with the execution of the electronic medical record application.

The data processing system 110 or component thereof such as the referral agent 140 installed on the referring computing device 125 can receive electronic medical record data as postscript data, or in other forms such as plain text data, bitmap data, or textual information data. The referral agent 140 can provide the data in any of these forms to the referral network engine 115 or the database 120 where this data can be used by the data processing system 110 to create a referral.

The electronic medical record can have various layouts that are not controlled by the data processing system 110. For example, the electronic medical record data 205 can be aggregated into a primary text box 225 as in FIG. 2, presented in a plurality of text boxes 225 of the screenshot 201 as in FIG. 2A, or displayed in other formats as controlled by an electronic medical record application as executed by the referring computing device 125.

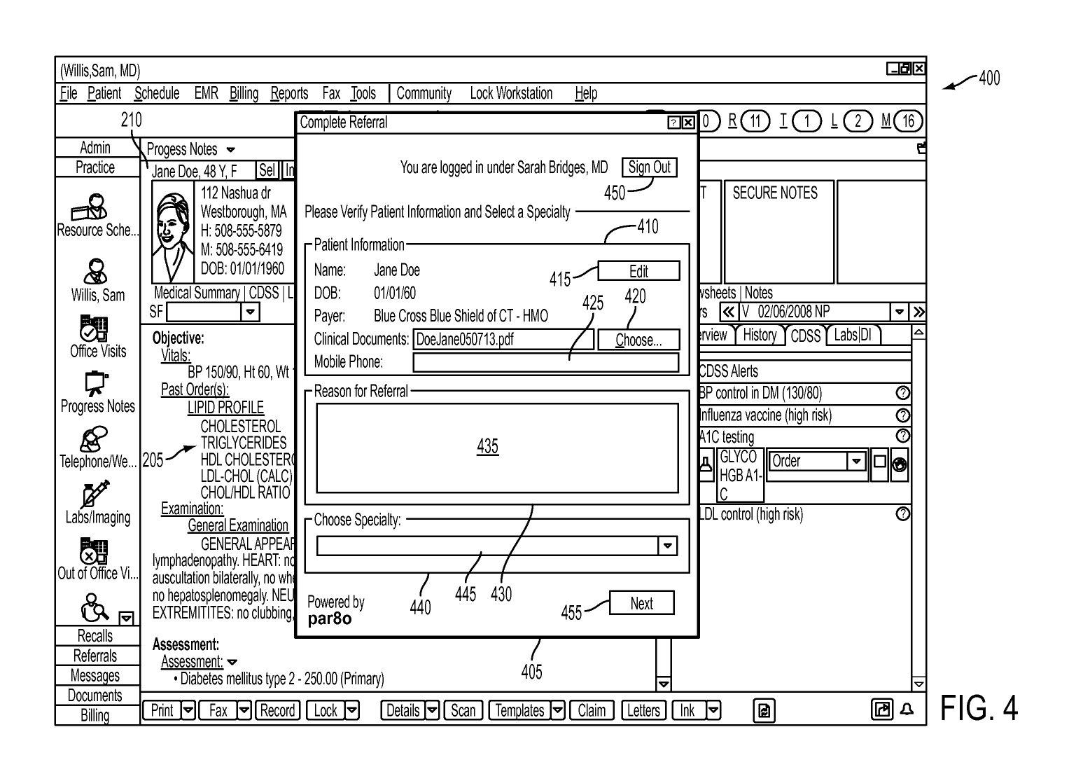

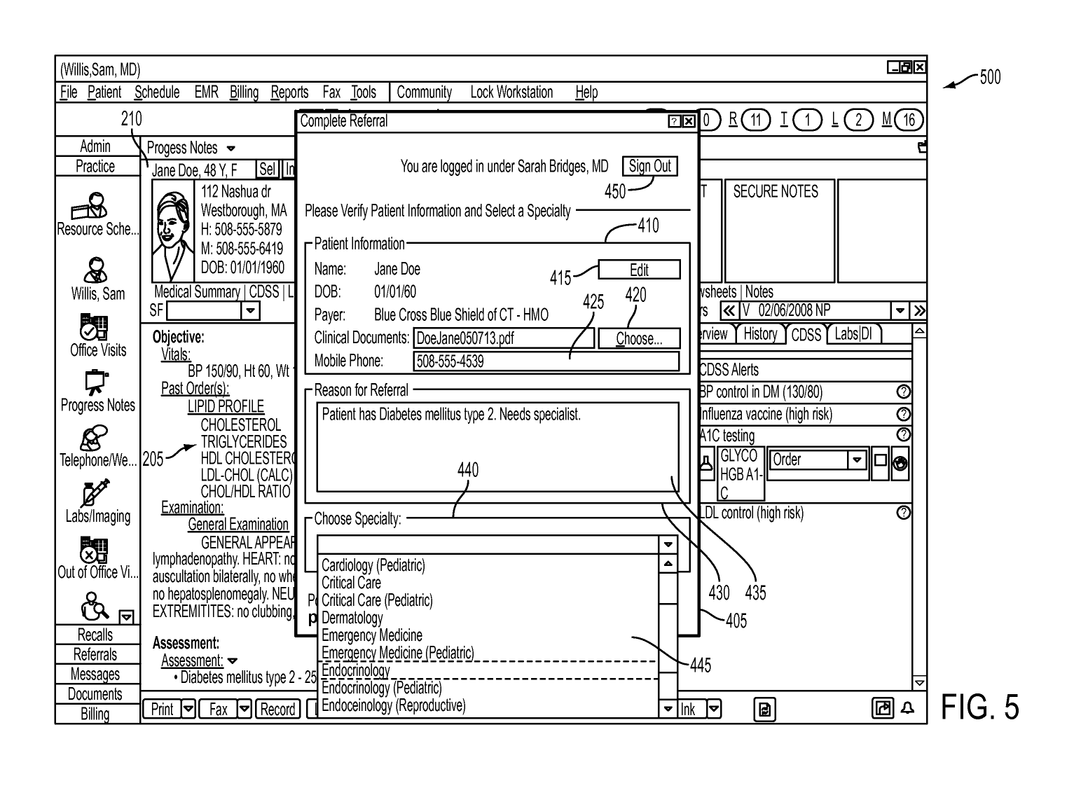

The data processing system 110 or a component thereof such as the referral network engine 115 can create a referral based on the electronic medical record data 205 received by the data processing system 110 from the referring computing device 125. For example, referring to FIG. 4 and FIG. 5, among others, the referral network engine 115 can prepare or generate a referral request document 405 that includes at least some of the electronic medical record data 205, such as health or identification information of a subject, subject to any applicable privacy laws. The referral request document 405 can be provided from the data processing system 110 via the computer network 105 to the referring computing device 125 for display by the referring computing device 125. For example, the referral request document 405 can be displayed as an online document, a web page, a template, a window, or a pop-up window that overlays a display of the electronic medical record data 205 of the subject 210 on the screenshot 400.

The referral request document 405 can display at least some of the electronic medical record data 205, and can prompt a user of the referring computing device 125 for additional information to complete the referral. For example, the referral request document 405 can include a patient information section 410. The patient information section 410 can include information about the subject 210, such as the name, date of birth, insurance provider, or mobile phone or other contact information for the subject 210. In some implementations, the data processing system 110 generates patient (or other subject) information from the received electronic medical record data 205, populates the referral request document 405 with this data, and provides the referral request document for display by the referring computing device.

The referral request document 405 can include one or more interfaces to prompt the user for more information to complete the referral. For example, the patient information section 410 can include at least one edit button 415. Responsive to a click of the edit button 415, the referral request document 405 can display an interface (not depicted in FIG. 4) for the entry of patient information data, such as a name of a new insurance provider. The patient information section 410 can also include at least one browse or selection interface such as a choose button 420. Responsive to a click of the choose button 420, the referral request document 405 can display an interface (not depicted in FIG. 4) for the attachment of documents to the referral request document 405. The documents can include clinical documents having information about the health of the subject 210 such as test results for example. The clinical documents or data contained therein can become part of the referral. In some implementations, the patient information section 410 includes at least one interface 425 for the entry of additional data such as a mobile telephone number of the subject 210 as in the example of FIG. 5 or of the service provider (e.g., physician) associated with the referring computing device.

The referral request document 405 can include at least one reason for referral section 430, which may include at least one reason for referral interface 435 such as a text box, window, or menu where a user of the referring computing device 125 can enter or select reasons for a referral, such as a medical condition of the subject 205. For example, the user of the referral computing device 125 can provide into the referral interface 435 an entry indicating that the subject 210 has diabetes mellitus type 2 and needs to see a specialist, as in FIG. 5.

The referral request document 405 can also include at least one specialist section 440 having at least one specialist interface 445 such as a text box, window, or menu. The user of the referring computing device 125 can enter or select a specialty such as a category of treatment or specialty associated with a service provider (e.g., physician) that may receive a referral at the recipient computing device 130. For example, via the specialist interface 445 a user of the referring computing device 125 can indicate that a recipient of a referral should have a specialty in pediatric cardiology, critical care, pediatric critical care, dermatology, or other specialties. In the example of FIG. 5 the user of the referral computing device 125 selects a specialty of endocrinology using the specialist interface 445. This example indicates a need for a referral to a service provider having a specialty in endocrinology to see the subject 210 suffering, for example, from diabetes.

The referral request document 405 can also indicate the identify of a service provider associated with the referring computing device 125 or with the electronic medical record application, e.g., “Sarah Bridges, MD” in the examples of FIG. 4 and FIG. 5. In some implementations, the data processing system 110 communicates with the referring computing device 125 to authenticate the user of the referring computing device 125 who is generating the referral directly or via a delegate. The referral request document 405 can include at least one sign out interface such as a sign out button 450 that the user of the referring computing device can click to close or exit the referral request document, for example without completing a referral or to sign out from an account that the referring physician (e.g., “Sarah Bridges, MD”) has established with the data processing system 110 to facilitate the creation, editing, and tracking of referrals. The referral request document 405 can include at least one next button 455 (or other type of link or interface) that can be actuated to provide data entered into the referral request document 405 to the referral network engine 115 or other data processing system 110 component to generate or complete a referral.

The referral request document 405 need not have the multiple interfaces or segregated sections as depicted in the examples of FIG. 4 and FIG. 5. For example, the referral request document can include a single interface (e.g., a text box) for entry or display of data used by the data processing system 110 to create a referral.

From, for example, unstructured postscript data, the data processing system 110 can generate structured data including at least partial referral data. For example, the data processing system 110 can convert unstructured postscript data, (e.g., data that may be used to communicate with the printer 135 to print an electronic medical record 205 but that has been intercepted or diverted by the referral agent 140 to the data processing system 110) to structured or human readable partial referral data. The partial referral data can indicate information about the subject of the referral, such as the patient information 410 or medical data. In some implementations, the referral request document 405 includes the partial referral data. The referral request document 405 including the partial referral data obtained from the unstructured postscript data can be provided from the data processing system 110 to the referring computing device 125 for display, e.g., overlaying the electronic medical record data 205 as in FIG. 4.

The referral agent 140 (or other data processing system 110 component) can intercept or extract unstructured postscript data corresponding to the electronic medical record data 205. For example, the referral agent 140 can intercept, at an operating system level of the referring computing device 125, postscript or other unstructured data representing the electronic medical record data 205. For example, by intercepting or extracting data representing the electronic medical record data 205 at the operating system level of the referring computing device 125, the data processing system 110 does not interfere with execution of the electronic medical record application by the referring computing device 125. In some implementations, the electronic medical record application uses the data processing system 110 as it would any printing device, for example the referral agent 140 can capture raw screen data for processing. In this example, the electronic medical record application does not detect or interact with the referral agent 140, and behavior of the electronic medical record application does not change.

The intercepted data can be provided to the referral network engine 115 or other data processing system 110 component to generate the referral request document 405 based on the unstructured data. In one implementation, the data processing system 110 extracts or obtains a copy of an unstructured representation of the electronic medical record data 205 without interacting with an application programming interface of the electronic medical record application, for example by obtaining the electronic medical record data 205 at an operating system level of the referring computing device or without controlling the target application associated with the electronic medical record of the subject 210.

In some implementations, the data processing system 110 identifies a network level event, e.g., a print command, and responsive to detection of this network level event the data processing system 110 creates a fork in the workflow of the electronic medical record application. For example, the referral request document 405 can have the appearance of a dialog box that is part of the electronic medical record application, (e.g., overlaying the electronic medical record data 205) when the referral request document 405 is in fact independent of the electronic medical record application. The referral agent 140, e.g., a daemon, script, or other computer program running at an operating system level of the referring computing device, can obtain and export the electronic medical record data 205 via the network 105 to the referral network engine 115 or to the database 120. The data processing system 110 can use the electronic medical record data 205 to create the referral request document 405 for display by the referring computing device, e.g., overlaying the electronic medical record data 205 or other display of the electronic medical record or other target application, without interfering with the execution of that target application.

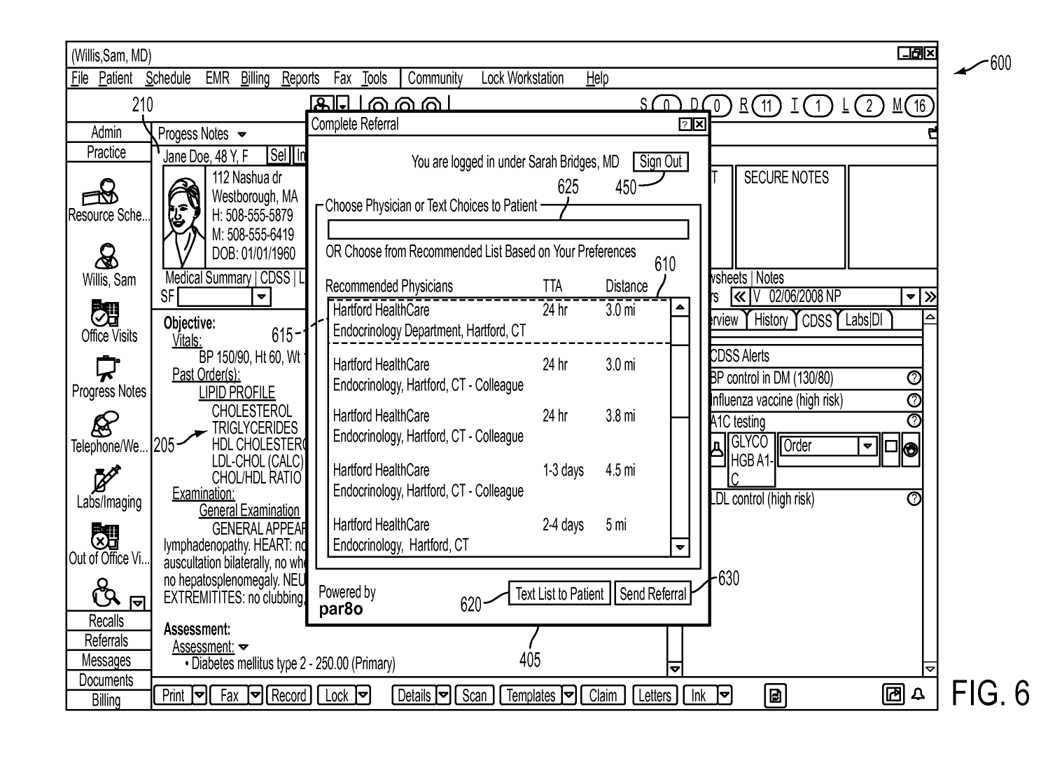

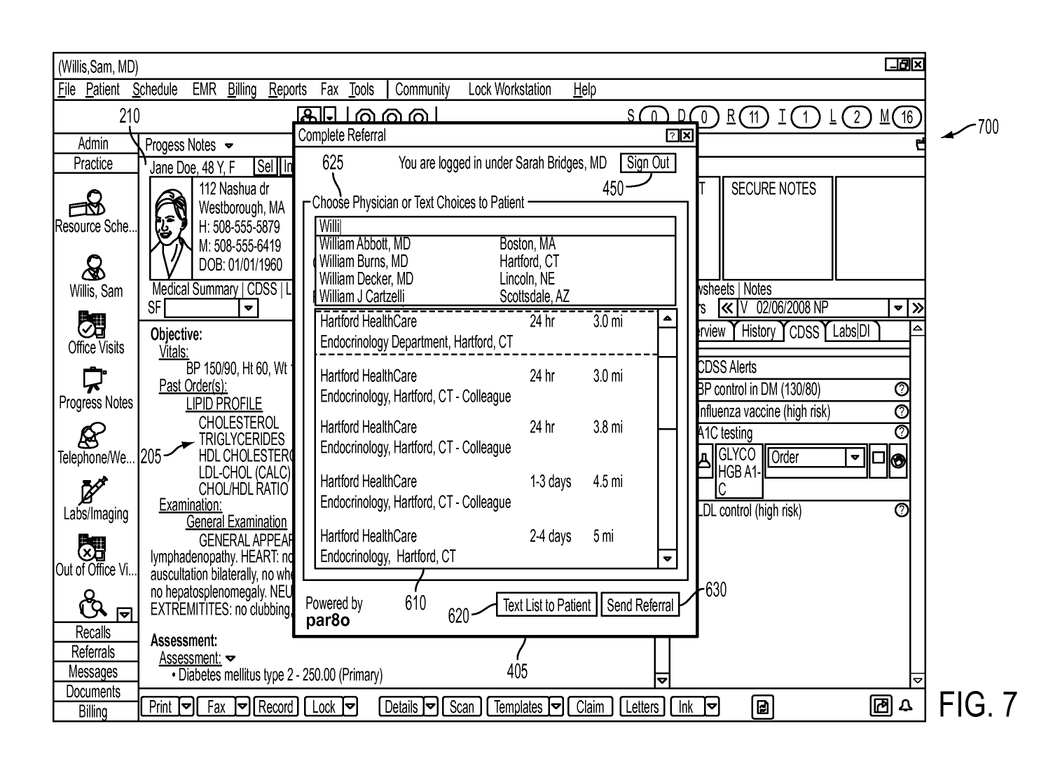

FIG. 6 and FIG. 7 depict example screenshots 600 and 700, respectively, of the referral request document 405 overlaying the electronic medical record data 205 of subject Jane Doe during the completion of a referral via data entry into the referral request document 405 via the referring computing device 125. For example, the referring computing device 125 directly or via the referral agent 140 can provide the data entered into the specialist interface 445 (e.g., a selection of endocrinology) to the data processing system 110 via the network 105. The data processing system 110 can receive this information and retrieve data associated with endocrinology from the database 120. For example, the data processing system can select a list of physicians, clinics, hospitals, or entities specializing in endocrinology and provide this list for display in at least one recommended physicians interface 610. The user can select at least one item from this list, for example by highlighting or clicking at least one selected specialist 615 such as the “Hartford HealthCare Endocrinology Department” in the example of FIG. 6. The recommended physicians interface 610 can include a window for the display of multiple potential recipients of a referral, as in the example of FIG. 6, with additional data such as the name or location of the specialist entity, a time window during which a specialist is available (e.g., within the next 1-3 days), or a distance between the service provider associated with the referring computing device 125 and the specialist service provider entity (e.g., 4.5 miles).

In one implementation, the referral request document 405 includes at least one text to patient button 620 (or other link or interface) that when actuated causes the referring computing device 125 or the referral agent 140 to communicate with the data processing system 110 with a command to send a text message, email, or other communication to a smartphone or other computing device associated with the subject 210. The data processing system 110 can receive this command and in response can generate and transmit a text or other message to the subject via the network 105. The referral request document 405 can also include at least one physician selection interface 625 where a user can enter a name of a physician, hospital, clinic, or other service provider entity rather than or in addition to selecting one from the recommended physicians interface 610. For example, a user can begin to type a name of a service provider into the physician selection interface 625. The data processing system 110 can detect this input and provide matching service providers, e.g., in real time or during a communication session between the data processing system 110 and the referring computing device 125, for selection by the user. The referral request document 405 can also include at least one send referral button 630 (or other link or interface) that when actuated communicates with the data processing system 110 to cause the data processing system to generate a referral or a request for a referral based on the data entered into the referral request document 405, such as a physician selected from the recommended physicians interface 610. Actuation of the send referral button 630 can indicate to the data processing system 110 that the referral is complete, or that the referring computing device 125 has provided sufficient information for the referral network engine 115 to generate a complete referral.

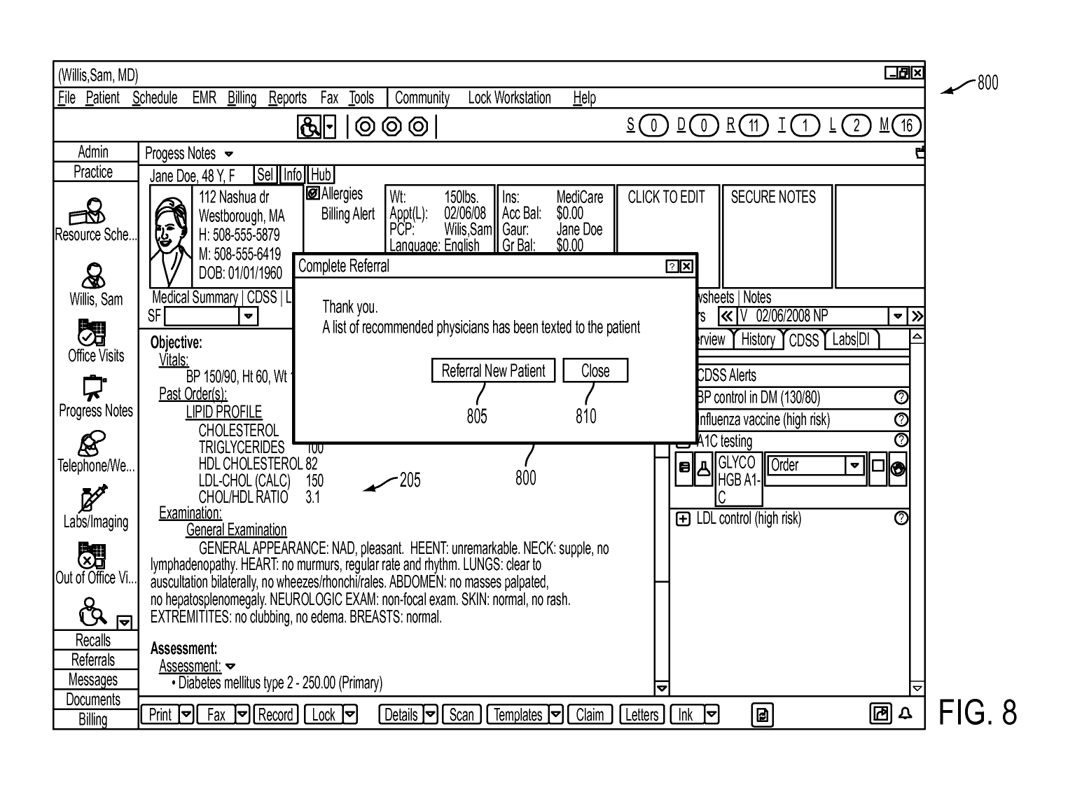

FIG. 8 depicts an example screenshot 800 of the referral completion document 800 overlaying the electronic medical record data 205 of subject Jane Doe. For example, responsive to actuation of the send referral button 630, the data processing system 110 can obtain from the referral request document 405 sufficient information about the subject to complete the referral, e.g., an indication that a complete referral has been provided to the data processing system 110 from the referring computing device 125. Responsive to receiving an indication of a complete referral, or an indication that the data processing system 110 can sufficient information to generate a referral, the data processing system can generate a referral and provide the referral (e.g., via email, instant message, or text message) to at least one recipient computing device 130. The referral can indicate information about the subject 210 such as the reasons for the referral or at least some of the electronic medical record data 205. A user of the recipient computing device 130 can accept the referral and schedule an appointment to see the subject 210.

In some implementations, the data processing system 110 and its components such as the referral network engine 115 can be part of or in communication with a system for providing information via a communications network to identify potential recipients of a referral, provide referral requests, and determine and adjust availability time periods during which a referral may be made as described in U.S. patent application Ser. No. 13/733,711, titled “Systems and Methods of Service Provider Identification in a Computer Network Environment” and filed on Jan. 3, 2013, which generally discusses a data processing system that can administer a referral network and which is incorporated herein by reference in its entirety.

The data processing system 110 can provide an acknowledgement of receipt of the referral to the referral computing device 125 for display by the referral computing device 125. For example, the acknowledgement receipt can include a pop-up window, online document, text message, email, instant message, or web page indicating that a referral has been completed, or that a referral has been provided to at least one recipient computing device 120. In some implementations, the acknowledgment receipt identifies physicians or other service providers who have received the referral.

The data processing system 110 can provide the referral completion document 800 via the network 105 for display by the referring computing device 125, for example overlaying the electronic medical record of a subject, as in the example of FIG. 8. The referral completion document 800 can indicate that the data processing system 110 has successfully created a request for a referral. In some implementations, the referral completion document 800 indicates that the referral request will be or has been provided from the data processing system 110 to the recipient computing device 130.

The referral completion document 800 can include at least one new subject referral button 805. In some implementations, actuation of the new subject referral button 805 causes the data processing system 110 to provide the referral request document 405 for display by the referring computing device 125 to obtain information used to create a new referral for the same subject (e.g., to see a second specialist or treat a second condition) or for a different subject such as a different patient. The referral completion document 800 can also include at least one close button 810 that, when actuated, closes or removes any templates or documents from display by the referring computing device 125.

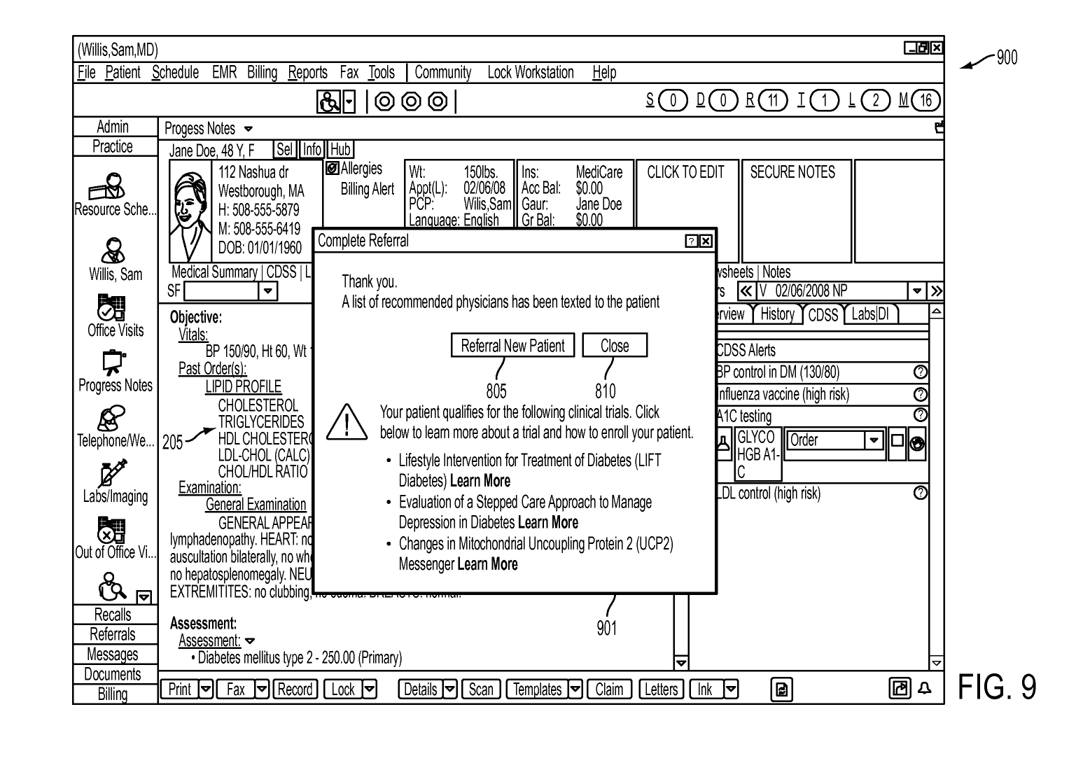

FIG. 9 depicts an example screenshot 900 of the clinical trial document 901 overlaying the electronic medical record data 205 of subject Jane Doe. The data processing system 110 can provide the clinical trial document 901 for display by the referring computing device 125, for example responsive to actuation of the close button 210, the send referral button 630, or to data entered into the interface 310. In some implementations, based on referral data obtained by the data processing system 110 from the referring computing device 125, the data processing system 110 can determine that the subject is eligible to participate in at least one clinical trial. For example, the data processing system 110 can compare the data used to generate the referral with clinical trial data stored in the database 120 to determine that a subject associated with the data used to generate the referral (e.g., Jane Doe) is eligible to participate in a clinical trial. The data processing system 110 can provide this information with the clinical trial document 901 via the network 105 for display by the referring computing device 125. The clinical trial document 901 can include data identifying at least one clinical trial. In some implementations, the clinical trial document 901 includes at least one link to another online document such as a web page associated with the clinical trial. This web page can be hosted by the data processing system 110 or an independent server or other computing device such as the recipient computing device 130. A user can click the link to visit the web page of the clinical trial. In some implementations, the data processing system 110 sends a complete referral (e.g., created by the referral network engine 115 based on electronic medical record data 205 or other data received from the referring computing device 125) to the recipient computing device 130. The recipient computing device 130 may be associated with a clinical trial for the subject to participate in the clinical trial, or may be associated with a specialist intended to receive the referral to treat a specific condition of the subject 210.

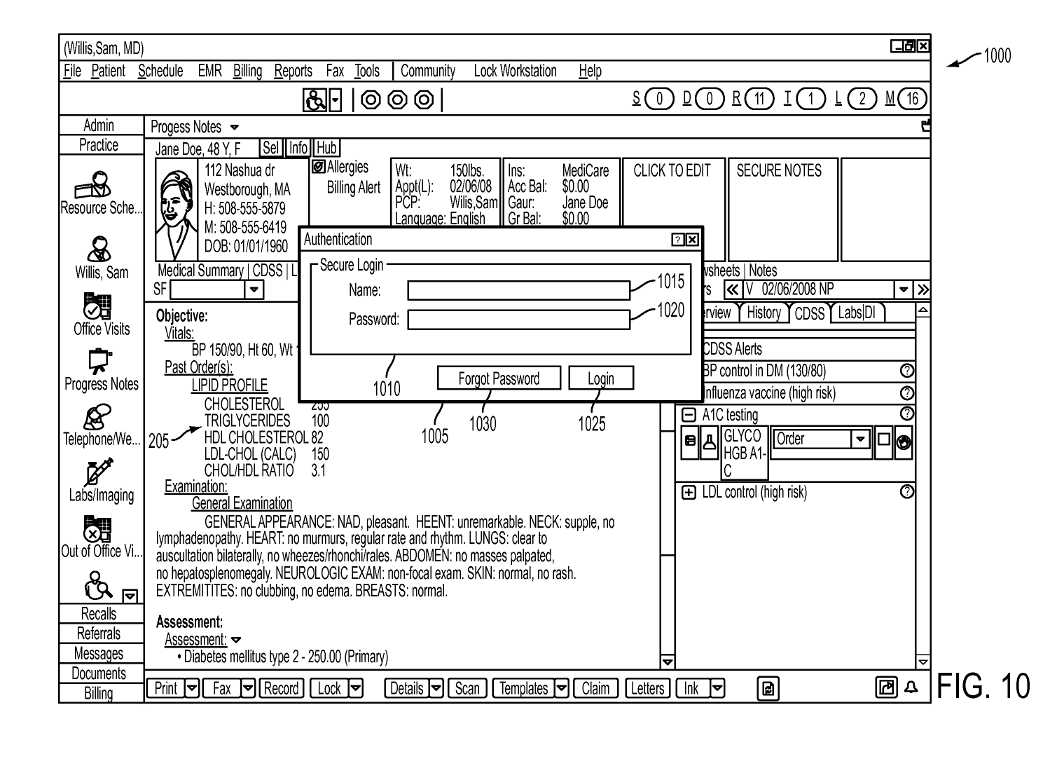

FIG. 10 depicts an example screenshot 1000 of the authentication document 1005 overlaying the electronic medical record data 205 of subject Jane Doe. In some implementations, the data processing system 110 can authenticate an identity of a user of the referring computing device 125 during or prior to creation of a referral. For example, prior to display of the referral request document 405 by the referring computing device 125, or responsive to the selection of the print icon 215 or other command or request for the data processing system 110 to obtain medical record data, the data processing system 110 can provide at least one authentication document 1005 for display by the referring computing device 125. For example, the authentication document 1005 can include a secure login area 1010 including at least one interface such as a name interface 1015 or a password interface 1020 for a user to enter a name, username, or password, or other user credentials. The authentication document 1005 can include at least one login button 1025. To logon to the referral system associated with the data processing system 110, the user of the referring computing device 125 can enter user credentials into one of the interfaces and actuate the login button 1025. The actuation of the login button 1025 can cause the data processing system 110 to obtain the user credentials, e.g., at the referral agent 140 or via the network 105. The authentication document 1005 can also include at least one password reset or forgotten password button 1030 that, when clicked or otherwise actuated, can cause the data processing system 110 to provide a password reminder for display by the referring computing device 125 or prompt the user of the referring computing device 125 to recover user authentication credentials.

Based on the user credentials the data processing system 110 can authenticate the user. For example, the data processing system 110 can compare user credentials received from the referring computing device 125 with credentials stored in the database to determine if the user has an account with the referral system operated by the data processing system 110. If there is a match and the user is authenticated, the data processing system can provide a verification communication for display by the referring computing device 125 to indicate that the user is logged on. In some implementations, subsequent to authentication of the user, the data processing system 110 can obtain the electronic medical record data (e.g., as unstructured data associated with the electronic medical record data 205) from the referring computing device 125 and can use this data to create or complete the referral.

In one implementation, the data processing system 110 receives user credentials, e.g., a name, username, or password, from the referring computing device 125 and denies authentication of the referring computing device 125, or of the user associated with the referring computing device 125. For example, the data processing system 110 can access credentials stored in the database 120 and determine that the credentials received from the referring computing device 125 are invalid or do not match those stored in the database. The data processing system 110 can provide a denial communication to the referring computing device 125 for display. The denial communication can indicate that access to the data processing system 110 is denied. For example, the data processing system 110 can block or refuse to accept electronic medical record data 205 transmitted from the referring computing device 125.

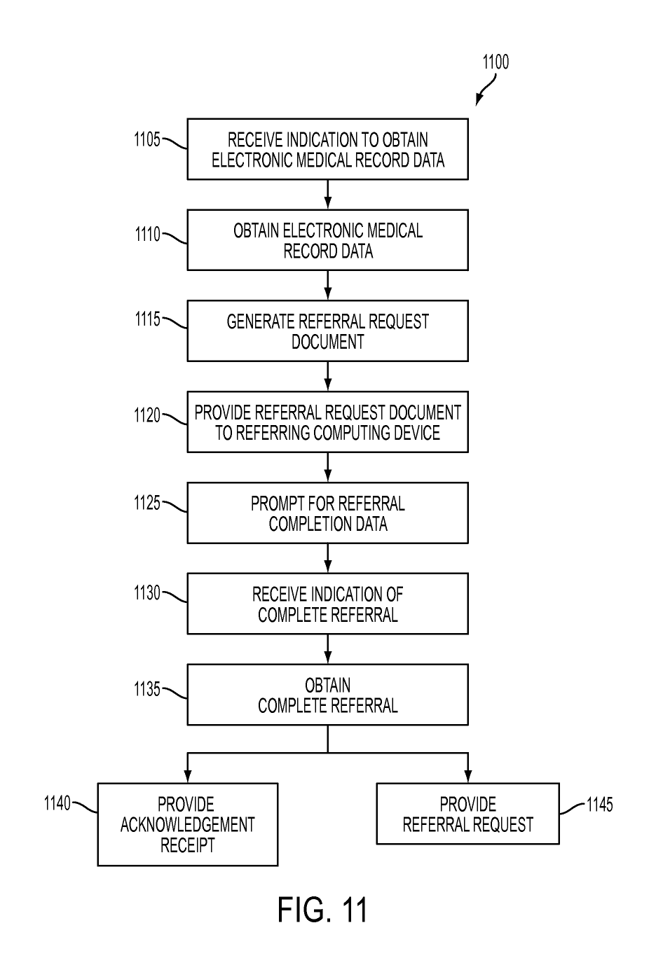

FIG. 11 is a flow chart 1100 depicting an example method 1100 of providing information via a computer network such as the network 105. The method 1100 can receive an indication to obtain the electronic medical record data (ACT 1105). For example, the data processing system 110 can receive a communication from the referring computing device 125 via the network 105 instructing the data processing system 110 to obtain the electronic medical record data 205. The method 1100 can also obtain electronic medical record data (ACT 1110). For example, the referral agent 140 can receive the electronic medical record data 205 responsive to a print command, screen capture command, screenshot command, or other input to the referring computing device 125.

In some implementations, the method 1100 generates the referral request template (ACT 1115). For example, the referral network engine 115 can obtain (e.g., unstructured) electronic medical record data 205 and can use this data to create the referral request document 405. The method 1100 can provide the referral request document 405 to the referring computing device 125 (ACT 1120) e.g., via the network 105. The method 1100 can prompt for referral completion data (ACT 1125). For example, the referral request document 405 can include interfaces, lists, drop down boxes, or text areas to prompt for and obtain data used by the data processing system 110. A user of the referring computing device can enter referral completion data into the referral request document 405 and instruct the referring computing device to provide this data to the data processing system 110 to complete a referral.

In some implementations, the method receives an indication of a complete referral (ACT 1130). For example, the data processing system 110 can receive a communication from the referring computing device 130 indicating that complete referral data has been provided to the data processing system 110. The data processing system can complete a referral (e.g., a request for a referral) using the complete referral data (ACT 1135). The method 1110 can provide an acknowledgement receipt (ACT 1140). For example, the data processing system 110 can provide data to the referring computing device 125 for display, indicating that a referral has been completed based on the electronic medical record data 205 or the referral completion data entered into the referral request document 405. The method 1100 can also provide the referral as a request to the recipient computing device 130 (ACT 1145) via the network 105.

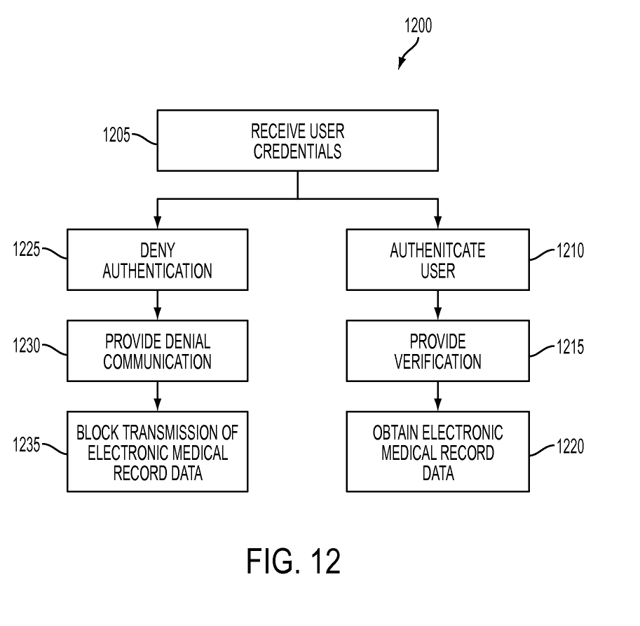

FIG. 12 is a flow chart depicting an example method 1200 of providing information via a computer network. The method 1200 can receive user credentials (ACT 1205). For example, the data processing system 110 can receive username, logon, password, or other credentials identifying a user of the recipient computing device 125, from the recipient computing device 125 via the network 105 as part of an overall process of creating a referral based at least in part on the electronic medical record data 205. The method 1200 can evaluate the user credentials to authenticate the user (ACT 1210) and can provide an indication of the verification of the user credentials to the referring computing device 125 for display (ACT 1215). In some implementations, subsequent to verification of the user, the data processing system 110 can obtain the electronic medical record data 205 from the referring computing device 125 (ACT 1220).

The method 1200 can also deny authentication of the user of the referring computing device 125 (ACT 1225). For example, rather than authenticating the user (ACT 1210), the data processing system 110 can evaluate the user credentials and determine that the user of the referring computing device is not authorized to create a referral (ACT 1225). In this example, the method 1200 can provide an authentication denial communication (ACT 1230), e.g., from the data processing system 110 to the referral computing device 125 for display. In some implementations, subsequent to denial of authentication of the user, the data processing system 110 can block transmission of the electronic medical record data 205 (ACT 1235). For example, the referral agent 140 can determine to not transmit the electronic medical record data 205 via the network 105 to another component of the data processing system 110.

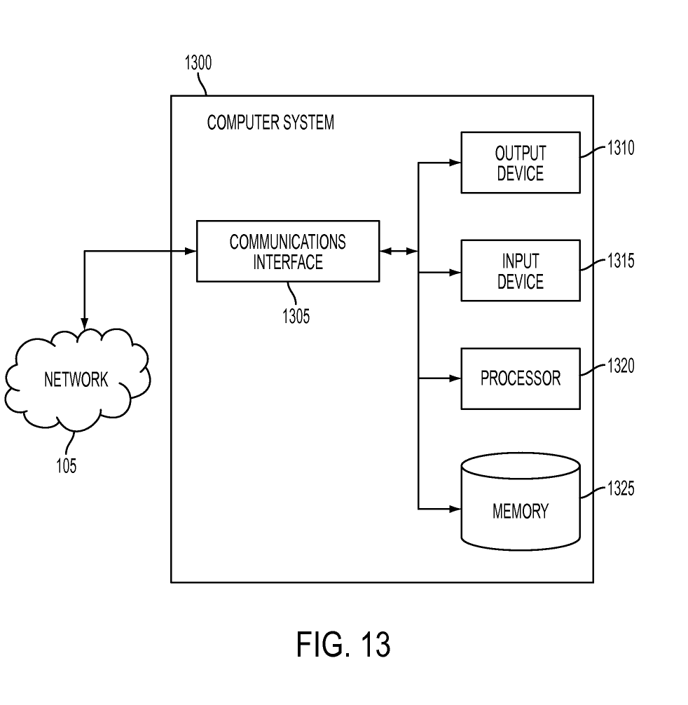

FIG. 13 shows the general architecture of an illustrative computer system 1300 that may be employed to implement any of the computer systems discussed herein (including the system 100 and its components such as the data processing system 110 and the referral network engine 115) in accordance with some implementations. The computer system 1300 can provide information via a communications network such as the network 105. The computer system 1300 of FIG. 13 comprises one or more processors 1320 communicatively coupled to memory 1325, one or more communications interfaces 1305, and one or more output devices 1310 (e.g., one or more display units) and one or more input devices 1315. The processors 1320 can be included in the data processing system 110 or the other components of the system 100 such as the referral network engine 115.

In the computer system 1300 of FIG. 13, the memory 1325 may comprise any computer-readable storage media, and may store computer instructions such as processor-executable instructions for implementing the various functionalities described herein for respective systems, as well as any data relating thereto, generated thereby, or received via the communications interface(s) or input device(s). Referring again to the system 100 of FIG. 1, any of the data processing system 110, the referral network engine 115, and the database 120 can include the memory 1325 to store referral input data, service provider data, and other referral network information such as referral network membership information. The processor(s) 1320 shown in FIG. 13 may be used to execute instructions stored in the memory 1325 and, in so doing, also may read from or write to the memory various information processed and or generated pursuant to execution of the instructions.

The processor 1320 of the computer system 1300 shown in FIG. 13 also may be communicatively coupled to or control the communications interface(s) 1305 to transmit or receive various information pursuant to execution of instructions. For example, the communications interface(s) 1305 may be coupled to a wired or wireless network, bus, or other communication means and may therefore allow the computer system 1300 to transmit information to and/or receive information from other devices (e.g., other computer systems). While not shown explicitly in the system of FIG. 1, one or more communications interfaces facilitate information flow between the components of the system 100. In some implementations, the communications interface(s) may be configured (e.g., via various hardware components or software components) to provide a website as an access portal to at least some aspects of the computer system 1300. Examples of communications interfaces 1305 include user interfaces (e.g., web pages) for electronic medical record data 205, referral completion data, referral input data or service provider data determined by the referral network engine 115 and provided for display at the referring computing device 125 or the recipient computing device 130.

The output devices 1310 of the computer system 1300 shown in FIG. 13 may be provided, for example, to allow various information to be viewed or otherwise perceived in connection with execution of the instructions. The input device(s) 1315 may be provided, for example, to allow a user to make manual adjustments, make selections, enter data or various other information, or interact in any of a variety of manners with the processor during execution of the instructions. Additional information relating to a general computer system architecture that may be employed for various systems discussed herein is provided at the conclusion of this disclosure.

Implementations of the subject matter and the operations described in this specification can be implemented in digital electronic circuitry, or in computer software, firmware, or hardware, including the structures disclosed in this specification and their structural equivalents, or in combinations of one or more of them. Implementations of the subject matter described in this specification can be implemented as one or more computer programs, i.e., one or more modules of computer program instructions, encoded on computer storage medium for execution by, or to control the operation of, data processing apparatus. The program instructions can be encoded on an artificially-generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The features disclosed herein may be implemented on a desktop, laptop, or other personal computer, a personal digital assistant, a smartphone, a tablet computing device, other mobile phone, handheld computer, or other computing device. The operations described in this specification can be implemented as operations performed by a data processing apparatus on data stored on one or more computer-readable storage devices or received from other sources.

The term computing device encompasses apparatuses, devices, or machines for processing data, such as a programmable processor, a computer, a system on a chip, or combinations thereof. The referring computing device 125 and the recipient computing device 130 can include special purpose logic circuitry, e.g., an FPGA (field programmable gate array) or an ASIC (application-specific integrated circuit). These devices can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures. The data processing system 110, including the referral network engine 115, the database 120, or the referral agent 140 can include or share one or more data processing apparatuses, computing devices, or processors.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatuses can also be implemented as, special purpose logic circuitry, e.g., an FPGA (field programmable gate array) or an ASIC (application-specific integrated circuit).

Processors suitable for the execution of a computer program may include general or special purpose microprocessors, or one or more processors of a digital computer. The processor can receive instructions and data from a read-only memory or a random access memory. The computing device can include a processor for performing actions in accordance with instructions and one or more memory devices for storing instructions and data. The computing device can also include, or be operatively coupled to receive data from or transfer data to, or both, one or more mass storage devices for storing data, e.g., magnetic, magneto-optical disks, or optical disks. However, the computer need not have such devices. The computing device can be embedded in another device, e.g., a mobile telephone, tablet computer, a personal digital assistant (PDA), a mobile audio or video player, a game console, a Global Positioning System (GPS) receiver, or a portable storage device (e.g., a universal serial bus (USB) flash drive), for example. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, implementations of the subject matter described in this discloser can be implemented on a computing device having a display device, e.g., a CRT (cathode ray tube), plasma, or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

The subject matter described herein can be implemented in a computing system that includes a back-end component, e.g., as a data server, or that includes a middleware component, e.g., an application server, or that includes a front-end component, e.g., a client computer having a graphical user interface or a web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system such as system 1300 or system 100 can include clients and servers. A client and server are generally remote from each other and typically interact through a communication network. The relationship of client and server arises by virtue of computer programs running on the respective computers and having a client-server relationship to each other. In some implementations, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of any inventions or of what may be claimed, but rather as descriptions of features specific to particular implementations of the systems and methods described herein. Certain features that are described in this specification in the context of separate implementations can also be implemented in combination in a single embodiment or implementation. Conversely, various features that are described in the context of a single implementation can also be implemented in multiple implementations separately or in any suitable sub combination. Moreover, although features may be described above as acting in certain combinations and even initially claimed as such, one or more features from a claimed combination can in some cases be excised from the combination, and the claimed combination may be directed to a sub combination or variation of a sub combination.

Similarly, while operations are depicted in the drawings in a particular order, this should not be understood as requiring that such operations be performed in the particular order shown or in sequential order, or that all illustrated operations be performed, to achieve desirable results. In some cases, the actions recited in the claims can be performed in a different order and still achieve desirable results. In addition, the processes depicted in the accompanying figures do not necessarily require the particular order shown, or sequential order, to achieve desirable results.

Multitasking and parallel processing may be implemented. The separation of various system components in the implementations described above should not be understood as requiring such separation in all implementations, and it should be understood that the described program components and systems can generally be integrated together in a single software product or packaged into multiple software products. For example, the data processing system 110 and the referral network engine 115 can be a single module or engine, or a logic device having one or more processing circuits.

Having now described some illustrative implementations, it is apparent that the foregoing is illustrative and not limiting, having been presented by way of example. In particular, although many of the examples presented herein involve specific combinations of method acts or system elements, those acts and those elements may be combined in other ways to accomplish the same objectives. Acts, elements and features discussed only in connection with one implementation are not intended to be excluded from a similar role in other implementations or implementations.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular may also embrace implementations including a plurality of these elements, and any references in plural to any implementation or element or act herein may also embrace implementations including only a single element. References in the singular or plural form are not intended to limit the presently disclosed systems or methods, their components, acts, or elements to single or plural configurations. References to any act or element being based on any information, act or element may include implementations where the act or element is based at least in part on any information, act, or element.

Any implementation disclosed herein may be combined with any other implementation or embodiment, and references to “an implementation,” “some implementation,” “an alternate implementation,” “various implementation,” “one implementation” or the like are not necessarily mutually exclusive and are intended to indicate that a particular feature, structure, or characteristic described in connection with the implementation may be included in at least one implementation or embodiment. Such terms as used herein are not necessarily all referring to the same implementation. Any implementation may be combined with any other implementation, inclusively or exclusively, in any manner consistent with the aspects and implementations disclosed herein.

References to “or” may be construed as inclusive so that any terms described using “or” may indicate any of a single, more than one, and all of the described terms.

Where technical features in the drawings, detailed description or any claim are followed by reference signs, the reference signs have been included for the sole purpose of increasing the intelligibility of the drawings, detailed description, and claims. Accordingly, neither the reference signs nor their absence have any limiting effect on the scope of any claim elements.

The systems and methods described herein may be embodied in other specific forms without departing from the characteristics thereof. For example, buttons of the referral request document 405 or the referral completion document 800 can include or be links, roll over areas, inputs, data entry points or other interfaces or inputs. Further, the referral network and system is applicable to environments other than health care environments. The data processing system can generate, provide, and obtain responses to referral requests and other information via a communications network involving service providers in non-medical services such as psychiatric services, or in other industries, such as sales, restaurants, merchants, or event or transportation tickets, for example. The foregoing implementations are illustrative rather than limiting of the described systems and methods. Scope of the systems and methods described herein is thus indicated by the appended claims, rather than the foregoing description, and changes that come within the meaning and range of equivalency of the claims are embraced therein.

What is claimed is:

1. A computer implemented method of providing information via a computer network, comprising:
receiving, from a referring computing device, an indication for a data processing system to obtain electronic medical record data displayed by the referring computing device;
obtaining, by a data processing system and via the computer network, the electronic medical record data;
generating, by a referral network engine of the data processing system, a referral request document based on the electronic medical record data;
providing the referral request document from the referral network engine to the referring computing device via the computer network for display by the referring computing device;
prompting, via the referral request document, for referral completion data;
receiving, by the data processing system via the computer network, an indication of a complete referral based on the referral completion data; and
obtaining, by the data processing system, the complete referral.

2. The method of claim 1, comprising:
detecting, by a referral agent installed on the referring computing device, the indication to obtain the electronic medical record data.

3. The method of claim 2, wherein receiving the indication to obtain the electronic medical record data includes at least one of:
detecting a keystroke from a keyboard associated with the referring computing device;
detecting a mouse click associated with the referring computing device;
detecting a print command associated with a target application executing on the referring computing device; and
detecting a screenshot capture command associated with the referring computing device.

4. The method of claim 1, comprising:
receiving by a referral agent installed on the referring computing device, a request for a referral based on input to a user interface displayed by the referring computing device;
receiving, by the data processing system from the referral agent via the computer network, the request for the referral.

5. The method of claim 1, comprising:
receiving, by the data processing system from the referring computing device, user credentials of a user associated with the referring computing device;
authenticating, by the data processing system, the user based on the user credentials;
providing a user credential verification communication, from the data processing system via the computer network, to a referral agent installed on the referring computing device; and
providing the electronic medical record data from the referring computing device to the data processing system via the computer network responsive to receipt of the user credential verification communication by the referral agent.

6. The method of claim 1, comprising:
receiving, by the data processing system from the referring computing device, user credentials of a user associated with the referring computing device;
denying authentication, by the data processing system, of the user based on the user credentials;
providing a denial communication, from the data processing system via the computer network, to the referring computing device; and
blocking transmission of the electronic medical record data from the referring computing device to the data processing system via the computer network responsive to receipt of the denial communication.

7. The method of claim 1, wherein the indication for the data processing system to obtain the electronic medical record data includes a print command, comprising:
receiving, by a referral agent installed on the referring computing device, postscript data including the electronic medical record data, the postscript data generated responsive to the print command; and
providing, by the referral agent, the postscript data from the referring computing device to the data processing system via the computer network.

8. The method of claim 7, wherein the postscript data is generated by a printer driver installed on the referring computing device.

9. The method of claim 1, comprising:
receiving, by a referral agent installed on the referring computing device, at least one of postscript data, plain text data, bitmap data, and textual information data, associated with the electronic medical record data; and
providing, by the referral agent, at least one of the postscript data, the plain text data, the bitmap data, and the textual information data from the referring computing device to the data processing system via the computer network.

10. The method of claim 1, comprising:
obtaining, by the data processing system, the electronic medical record data as unstructured postscript data;
generating, by the data processing system from the unstructured postscript data, structured data including partial referral data;
including the partial referral data with the referral request document; and
providing the referral request document including the partial referral data for display by the referring computing device.

11. The method of claim 1, comprising:
intercepting, at an operating system level of the referring computing device, unstructured data corresponding to the electronic medical record data;
providing the unstructured data to the data processing system; and
generating the referral request document based on the unstructured data.

12. The method of claim 1, comprising:
extracting, by a referral agent installed on the referring computing device, an unstructured representation of the electronic medical record data displayed by an electronic medical record application executing at the referring computing device.

13. The method of claim 12, comprising:
extracting the unstructured representation of the electronic medical record data in the absence of interaction between the referral agent and an application programming interface of the electronic medical record application.

14. The method of claim 1, wherein the electronic medical record data is displayed by an electronic medical record application executing at the referring computing device, comprising:
obtaining the electronic medical record data without controlling the electronic medical record application.

15. The method of claim 1, comprising:
obtaining, by the data processing system, electronic medical record data from a display of an electronic medical record application executing at the referring computing device without altering execution of the electronic medical record application.

16. The method of claim 1, comprising:
providing an acknowledgement of receipt of the referral from the data processing system to the referring computing device for display by the referring computing device.

17. The method of claim 1, comprising:
providing the complete referral as a referral request from at least one of the data processing system and the referring computing device to a recipient computing device via the computer network.

18. A system of providing information via a computer network, comprising:
a data processing system having a referral network engine and a database, the data processing system configured to:
receive, from a referring computing device, an indication to obtain electronic medical record data via the referring computing device;
obtain, via the computer network, the electronic medical record data;
generate, by the referral network engine of the data processing system, a referral request document based on the electronic medical record data;
provide the referral request document from the referral network engine to the referring computing device via the computer network for display by the referring computing device;
receive, via the computer network, an indication of a complete referral based on the referral completion data; and
obtain the complete referral.

19. The system of claim 18, comprising:
a referral agent installed on the referring computing device and configured to detect the indication to obtain the electronic medical record data.

20. The system of claim 18, comprising:
a referral agent installed on the referring computing device and configured to receive a request for a referral based on input to a user interface displayed by the referring computing device; and
the data processing system configured to receive, from the referral agent via the computer network, the request for the referral.

21. The system of claim 18, comprising the data processing system configured to:
receive, from the referring computing device, user credentials of a user associated with the referring computing device;
authenticate the user based on the user credentials;
provide a user credential verification communication, via the computer network, to a referral agent installed on the referring computing device; and
receive the electronic medical record data from the referring computing device via the computer network responsive to receipt of the user credential verification communication by the referral agent.

22. The system of claim 18 wherein the indication to obtain the electronic medical record data includes a print command, comprising:
a referral agent configured for installation on the referring computing device to receive postscript data including the electronic medical record data, the postscript data generated responsive to the print command; and
the referral agent configured to provide the postscript data from the referring computing device to the data processing system via the computer network.

23. The system of claim 18, comprising:
a referral agent configured to intercept, at an operating system level of the referring computing device, unstructured data corresponding to the electronic medical record data;
the referral agent configured to provide the unstructured data to the data processing system; and
the data processing system configured to generate the referral request document based on the unstructured data.

24. A non-transient computer readable medium having instructions to provide information via a computer network, the instructions comprising instructions to:
receive, from a referring computing device, an indication to obtain electronic medical record data displayed by the referring computing device;
obtain, via the computer network, the electronic medical record data;
generate a referral request document based on the electronic medical record data;
provide the referral request document to the referring computing device via the computer network for display by the referring computing device;
prompt, via the referral request document, for referral completion data;
receive, via the computer network, an indication of a complete referral based on the referral completion data; and
obtain the complete referral.

25. The computer readable medium of claim 24, comprising instructions to:
detect the indication to obtain the electronic medical record data based on at least one of a keystroke from a keyboard associated with the referring computing device, a mouse click associated with the referring computing device, a print command associated with a target application executing on the referring computing device, and a screenshot capture command associated with the referring computing device.

26. The computer readable medium of claim 24, comprising instructions to:
obtain the electronic medical record data as unstructured postscript data;
generate from the unstructured postscript data, structured data including partial referral data;
include the partial referral data with the referral request document; and
provide the referral request document including the partial referral data for display by the referring computing device.

27. The computer readable medium of claim 24, comprising instructions to:
provide the referral as a referral request to a recipient computing device via the computer network.
